(19) United States
(12) Patent Application Publication
(10) Pub. No.: US 2025/0162057 A1
(43) Pub. Date: May 22, 2025

(54) WELDING ROBOT

(71) Applicant: DAIHEN CORPORATION, Osaka (JP)

(72) Inventor: Sho FUJISAWA, Osaka (JP)

(73) Assignee: DAIHEN CORPORATION, Osaka (JP)

(21) Appl. No.: 18/755,286

(22) Filed: Jun. 26, 2024

(30) Foreign Application Priority Data
Nov. 21, 2023 (JP) 2023-197248

(51) Int. Cl. B23K 9/32; B23K 9/06; B25J 11/00

(52) U.S. Cl. CPC B23K 9/32; B23K 9/06; B25J 11/005

(57) ABSTRACT

A welding robot which can easily perform welding while using the robot without laborious preparation for manual welding or teaching.

A welding robot includes a welding torch portion connected to a distal end of an arm which is movable in accordance with an external force, a grasping portion capable of moving the welding torch portion, and a switch portion, and the switch portion enables performance of arc welding in an ON state, while disables the performance of the arc welding in an OFF state.

### BACKGROUND

### Field

The present invention relates to a welding robot.

### Description of Related Art

The Patent Publication JP-A-2015-199174 describes, with regard to a so-called general human-cooperative type robot, an art of direct teaching, by which robot-teaching can be performed more easily than using a teach-pendant by a lead-through operation in which a worker manually teaches to the robot a taught position, and by which the robot can be moved easily by a handle at the time of the direct-teaching.

### SUMMARY

On the other hand, when welding is to be performed by a robot, it is necessary to fix, at first, a work to be joined by a jig or the like and then, the work is tack-welded by manual welding using a welding machine, or the work needs to be tack-welded after the teaching by the robot. In the tack-welding in the former, laborious preparation for performing manual welding is needed, and in the tack-welding in the latter, laborious teaching only for the tack-welding is needed.

Thus, an object of the present invention is to provide a welding robot which can easily perform welding while using the robot without laborious preparation for manual welding or teaching.

A welding robot according to an aspect of the present invention includes a welding torch portion connected to a distal end of an arm which is movable in accordance with an external force, a grasping portion capable of moving the welding torch portion, and a switch portion, and the switch portion is capable of performing arc welding in an ON state and disables performing the arc welding in an OFF state.

According to this aspect, the grasping portion capable of moving the welding torch portion which is movable in accordance with the external force can be provided and moreover, it becomes possible that, when the worker brings the switch portion into the ON state, the arc welding is enabled, while if the switch portion is brought into the OFF state, the arc welding is disabled.

In the aforementioned aspect, it may be so configured that a switching portion which switches between a weldable mode in which the performance of the arc welding is enabled and a non-weldable mode in which the performance of the arc welding is disabled is further provided, and when the switching portion is brought into the ON state in the weldable mode, the arc welding is started while, when the switch portion is brought into the OFF state in the weldable mode, the arc welding is finished.

According to this aspect, by further providing the switching portion which switches between the weldable/non-weldable mode, when the switch portion is brought into the ON state in the weldable mode, the arc welding can be started, while, when the switch portion is brought into the OFF state in the weldable mode, the arc welding can be finished.

In the aforementioned aspect, it may be so configured that the arc welding is not started even when the switch portion is brought into the ON state in the non-weldable mode.

According to this aspect, by switching the weldable/non-weldable mode to the non-weldable mode, it can be guarded that the arc welding is not performed.

In the aforementioned aspect, when the switch portion is in the OFF state, the movement of the welding torch portion in accordance with the external force is disabled, while, when the switch portion is in the ON state, the welding torch portion may move accompanied by movement of the grasping portion.

According to this aspect, when the worker brings the switch portion into the OFF state, the welding torch portion can be made unmovable even if an external force is applied, and when the worker brings the switch portion into the ON state, the welding torch portion can be made movable by the external force applied to the welding torch portion via the grasping portion.

In the aforementioned aspect, the switch portion may be provided so as to be located on a lower side of the grasping portion when the worker works by grasping the grasping portion.

According to this aspect, the worker can perform welding with such a feeling of performing the manual welding by using a general device exclusively for manual welding.

In the aforementioned aspect, the grasping portion may be a tool which can be mounted in the vicinity of the welding torch portion.

According to this aspect, when the worker performs a welding work, welding can be performed easily while visually checking the arc generated from the vicinity of a distal end of the welding torch portion and a welding spot.

According to the present invention, a welding robot capable of welding easily while using the robot can be provided without laborious preparation for the manual welding or teaching.

### BRIEF DESCRIPTION OF DRAWINGS

FIG. 1 is a diagram exemplifying a configuration of a robot system including a welding robot according to an Embodiment; and

FIG. 2 is a view with a welding torch portion and a grasping portion constituting the welding robot in FIG. 1 in an enlarged manner.

### DETAILED DESCRIPTION

With reference to the attached drawings, preferred embodiments of the present invention will be explained. It is to be noted that, in each drawing, those with the same signs have the same or similar configurations. Moreover, since the drawings are schematic, dimensions and ratios among each constituent element are different from actual ones.

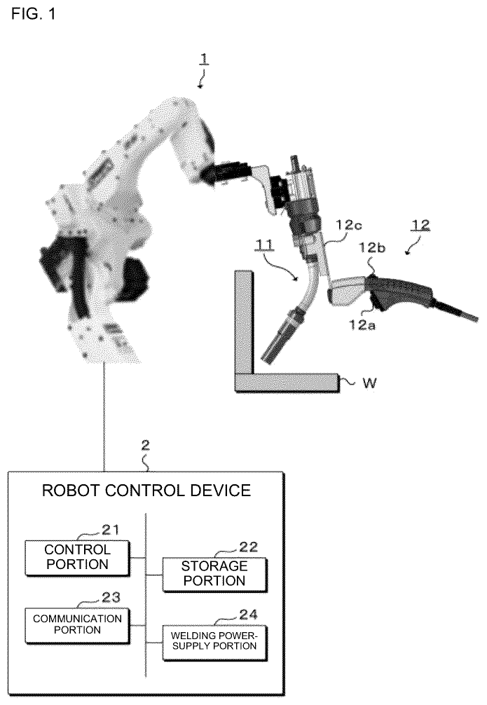

FIG. 1 is a diagram exemplifying a configuration of a robot system including a welding robot 1 according to an Embodiment. The robot system includes the welding robot 1 and a robot control device 2, for example. The welding robot 1 and the robot control device 2 can be connected via a network including wires such as a communication cable or wirelessly. It is to be noted that a teaching pendant may be included in the robot system. The teaching pendant can be connected to the robot control device 2 and is an operation terminal for a worker to teach an operation of the welding robot 1.

The robot control device 2 is a control unit which controls an operation of the welding robot 1 and includes a control portion 21, a storage portion 22, a communication portion 23, and a welding power-supply portion 24, for example.

The control portion 21 is a processor and controls the welding robot 1 and the welding power-supply portion 24 by executing a work program such as a welding program stored in the storage portion 22. The communication portion 23 controls communication with each device connected via a network.

The welding power-supply portion 24 supplies a welding current, a welding voltage and the like to the welding robot 1 in accordance with a processing condition of welding determined in advance in order to generate an arc between a distal end of a welding wire and a work W, for example. The processing condition of welding includes data items such as a welding condition, a welding start position, a welding end position, a welding distance, an attitude of a welding torch and the like, for example. The welding condition includes data items such as a welding current, a welding voltage, a welding speed, a wire feeding speed, a work thickness and the like, for example. The welding power-supply portion 24 may be provided separately from the robot control device 2.

The welding robot 1 is a manipulator which performs arc welding to the work W, which is a welding target, in accordance with the processing condition of the welding set in the robot control device 2. The welding robot 1 has an articulated arm provided on a base member fixed to a floor surface or the like of a plant, a welding torch portion 11, which is one of tools connected to the distal end of the articulated arm, and a grasping portion 12, which is one of the tools which can be mounted on the welding torch portion 11, for example.

The welding robot 1 is a so-called cooperative robot capable of detecting an external force, is a robot that the worker can directly touch the arm so as to perform a direct operation, and is capable of arc welding during the direct operation.

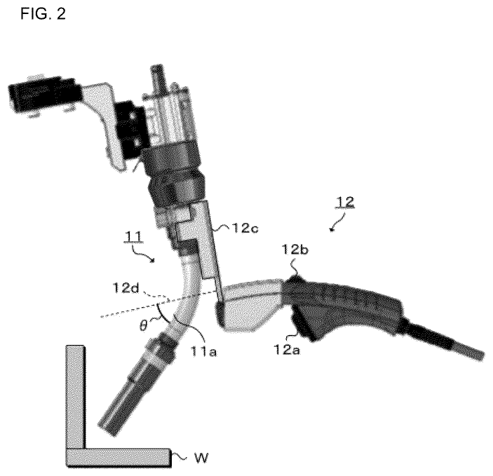

The grasping portion 12 shown in FIG. 1 and FIG. 2 is a tool mounted on the welding torch portion 11 when the welding robot 1 is directly operated.

When the welding robot 1 is directly operated, the worker can move the welding torch portion 11 to the welding spot and weld the welding spot by moving the grasping portion 12 while grasping a main body thereof. The welding may be tack-welding or may be regular welding.

The grasping portion 12 has a switch portion 12a, a switching portion 12b and a mounting portion 12c, for example.

The switch portion 12a is a so-called enable switch. When the switch portion 12a is pressed so as to be brought into an ON state, a servo power-supply is turned on, and the welding robot 1 is brought into an operable state. On the other hand, when the switch portion 12a is released into an OFF state, the servo power-supply is turned off, and the operation of the welding robot 1 is stopped.

The switch portion 12a is preferably provided so as to be located on a lower side of the grasping portion 12 when the worker performs the work by grasping the grasping portion 12. As a result, the worker can perform welding with the same feeling as manual welding using a device exclusively for general manual welding.

Here, when the switch portion 12a is in the OFF state, in order to further enhance safety, the welding robot 1 including the welding torch portion 11 may be set to be manually unmovable (in accordance with the external force). In this case, it is preferable that, when the switch portion 12a is brought into the ON state, the welding robot 1 including the welding torch portion 11 is made operable manually. As a result, when the switch portion 12a is brought into the ON state, by moving the grasping portion 12 by the worker, the welding torch portion 11 can be moved toward the welding spot with the movement.

The switching portion 12b is a button switch which switches a weldable/non-weldable mode of the arc welding of the welding robot 1. The weldable/non-weldable mode of the arc welding includes a weldable mode which enables an arc welding operation and a non-weldable mode which disables the arc welding operation. The worker switches the weldable/non-weldable mode of the arc welding into either one of the weldable mode and the non-weldable mode by operating the switching portion 12b.

By providing the switching portion 12b, the arc welding can be controlled as follows together with the operation of the switch portion 12a.

When the weldable/non-weldable mode of the arc welding is the weldable mode, by bringing the switch portion 12a into the ON state, the arc welding is started, while by bringing the switch portion 12a into the OFF state, the arc welding is finished.

When the weldable/non-weldable mode of the arc welding is the non-weldable mode, the arc welding is not performed whichever of the ON state and the OFF state the switch portion 12a is in.

The switching portion 12b is preferably provided at a position on an upper side of the grasping portion 12 and not hidden by the hand of the worker, when the worker performs the operation by grasping the grasping portion 12. As a result, the worker can visually check the switching portion 12b easily and perform the switching operation between the weldable/non-weldable mode of the arc welding easily.

The mounting portion 12c is a member when the grasping portion 12 is to be mounted on the welding torch portion 11. For example, the mounting portion 12c is fitted in the welding torch portion 11 so that the grasping portion 12 can be incorporated in the welding torch portion 11.

Here, the position where the grasping portion 12 is mounted is preferably in the vicinity of the welding torch portion 11. In addition, as shown in FIG. 2, it is preferable that the grasping portion 12 is mounted so that an angle θ formed by an extension line 12d from a main-body upper surface of the grasping portion 12 and a line by a distal end portion 11a of the welding torch portion 11 becomes approximately 40 to 60 degrees. In other words, when the worker performs the welding work, it is preferable that the grasping portion 12 is mounted at the position and by the angle that the welding can be performed easily while visually checking the arc generated from the welding wire located in the vicinity of the distal end of the welding torch portion 11 and the welding spot.

As described above, according to the welding robot 1 according to the Embodiment, by providing the switch portion 12a on the grasping portion 12 capable of moving the welding torch portion 11 movable in accordance with the external force, the arc welding can be performed when the worker brings the switch portion 12a into the ON state, while by bringing the switch portion 12a into the OFF state, the arc welding can be disabled.

Moreover, by providing the switching portion 12b for switching the weldable/non-weldable mode on the grasping portion 12, when the worker brings the switch portion 12a into the ON state in the weldable mode, the arc welding can be started, while by bringing the switch portion 12a into the OFF state in the weldable mode, the arc welding can be finished.

Furthermore, when the worker switches the weldable/non-weldable mode to the non-weldable mode, it is possible to guard so that the arc welding is not performed.

Therefore, according to the welding robot 1 according to the Embodiment, the welding can be performed easily while using the robot without a labor of preparation for the manual welding or teaching.

It is to be noted that the present invention is not limited to the aforementioned Embodiment but can be worked in the other various forms within a range not departing from the purpose of the present invention. Thus, the aforementioned Embodiment is merely exemplification in any point and should not be interpreted in a limited manner.

For example, in the aforementioned Embodiment, the switch portion 12a and the switching portion 12b are provided on the grasping portion 12, but spots on which the switch portion 12a and the switching portion 12b are provided are not limited to the grasping portion 12. For example, the switch portion 12a and the switching portion 12b may be provided on the main body of the welding robot 1.

What is claimed is:

1. A welding robot comprising:
a welding torch portion connected to a distal end of an arm which is movable in accordance with an external force;
a grasping portion capable of moving the welding torch portion; and
a switch portion, wherein
the switch portion enables performance of arc welding in an ON state and disables the performance of the arc welding in an OFF state.

2. The welding robot according to claim 1, further comprising:
a switching portion which switches between a weldable mode in which performance of arc welding is enabled and a non-weldable mode in which the performance of the arc welding is disabled, wherein
when the switch portion is brought into the ON state in the weldable mode, the arc welding is started while when the switch portion is brought into the OFF state in the weldable mode, the arc welding is finished.

3. The welding robot according to claim 2, wherein
even when the switch portion is brought into the ON state in the non-weldable mode, the arc welding is not started.

4. The welding robot according to claim 1, wherein
when the switch portion is in the OFF state, movement of the welding torch portion in accordance with the external force is disabled, while when the switch portion is in the ON state, the welding torch portion moves accompanied by movement of the grasping portion.

5. The welding robot according to claim 1, wherein
the switch portion is provided to be located on a lower side of the grasping portion when a worker performs a work by grasping the grasping portion.

6. The welding robot according to claim 1, wherein
the grasping portion is a tool capable of being mounted in the vicinity of the welding torch portion.
